(19) United States
(12) Patent Application Publication
(10) Pub. No.: US 2022/0328002 A1
(43) Pub. Date: Oct. 13, 2022

(54) DISPLAY DEVICE AND CONTROL METHOD PERFORMED BY DISPLAY DEVICE

(71) Applicant: JOLED INC., Tokyo (JP)

(72) Inventor: Masanori OHARA, Tokyo (JP)

(73) Assignee: JOLED INC., Tokyo (JP)

(21) Appl. No.: 17/715,099

(22) Filed: Apr. 7, 2022

(30) Foreign Application Priority Data
Apr. 12, 2021 (JP) 2021-067126

(51) Int. Cl. G09G 3/3233

(52) U.S. Cl. CPC G09G 3/3233; G09G 2300/0852; G09G 2300/0452

(57) ABSTRACT

A display device includes a display unit and a control circuit. Each of the pixel circuits includes a first sub-pixel circuit and a second sub-pixel circuit. The first sub-pixel circuit includes a first light-emitting element, a first drive transistor, a first capacitor, and a first writing transistor. The second sub-pixel circuit includes: a second light-emitting element; a second drive transistor that supplies a current to the second light-emitting element; a second capacitor that holds electric charge corresponding to the video signal; and a second writing transistor connected to the second capacitor. The first capacitor has a capacitance greater than a capacitance of the second capacitor. The control circuit controls, based on a temperature related to the display unit, a threshold compensation period of each of the first drive transistor and the second drive transistor in each of the pixel circuits.

### CROSS REFERENCE TO RELATED APPLICATION

The present application is based on and claims priority of Japanese Patent Application No. 2021-067126 filed on Apr. 12, 2021. The entire disclosure of the above-identified application, including the specification, drawings and claims is incorporated herein by reference in its entirety.

### FIELD

The present disclosure relates to a display device and a control method performed by the display device.

### BACKGROUND

Up to now, active-matrix display devices in which light-emitting elements such as organic electroluminescent (EL) elements are used (hereinafter, referred to as display devices) have been in practical use (see, for example, PLT 1). Such a display device includes pixel circuits arranged in a matrix. Each of the pixel circuits is configured of, for example, three sub-pixel circuits on which organic EL elements that respectively emit red (R) light, green (G) light, and blue (B) light are mounted. Each of the sub-pixel circuits includes, for example, an initialization transistor, a reference transistor, a writing transistor, and a capacitor. Each of the initialization transistor, the reference transistor, and the writing transistor is switched based on a control signal from a gate driver. The display device controls the light-emission luminances of the organic EL elements for each sub-pixel circuit based on signals from the gate driver and a source driver, to thereby display a color image.

Among the respective organic EL elements of the sub-pixel circuits, the light emission lifetime of an organic EL material used for the blue organic EL element that emits blue light (that is, the light emission lifetime of the organic EL material in the case where a predetermined current density is continuously applied to the organic EL material) is shorter than the light emission lifetimes of organic EL materials respectively used for the red organic EL element that emits red light and the green organic EL element that emits green light. That is, the blue organic EL element deteriorates more easily than the red organic EL element and the green organic EL element. Therefore, in the conventional display devices, the pixel area of each blue organic EL element is set to be larger than the pixel areas of each red organic EL element and each green organic EL element, whereby the current density in the blue organic EL element is reduced. Consequently, the capacitance of the capacitor in the blue sub-pixel circuit including the blue organic EL element is designed to be greater than the capacitances of the capacitors in the sub-pixel circuits of the other colors, considering a balance with the characteristic of the blue organic EL element.

### CITATION LIST

### Patent Literature

PTL 1: Japanese Unexamined Patent Application Publication No. 2020-118952

### SUMMARY

### Technical Problem

In each sub-pixel circuit, a slight amount of current (hereinafter, referred to as “off-current”) flows in the writing transistor and the reference transistor even in an off-state (a non-conductive state or a high resistance state). After data writing (that is, after electric charge corresponding to a luminance value is accumulated in the capacitor), this off-current causes the electric charge to be released from the capacitor via the writing transistor and the reference transistor. Here, the luminance value of each sub-pixel circuit corresponds to a gate-source voltage of a drive transistor, and the gate-source voltage depends on the electric charge accumulated in the capacitor. Here, as described above, the capacitance of the capacitor in the blue sub-pixel circuit is greater than the capacitances of the capacitors in the sub-pixel circuits of the other colors. On the other hand, the amount of electric charge released from the capacitor by the off-current is similar for every sub-pixel circuit. Accordingly, for the ratio of: the amount of electric charge released from the capacitor by the off-current; to the capacitance of the capacitor, the blue sub-pixel circuit is lower than the sub-pixel circuits of the other colors. Accordingly, for the change rate of the gate-source voltage of the drive transistor by the off-current, the blue sub-pixel circuit is lower than the sub-pixel circuits of the other colors. That is, for an influence on the luminance of the organic EL element in each sub-pixel circuit resulting from the off-current, the blue sub-pixel circuit is smaller than the sub-pixel circuits of the other colors. Therefore, the white balance of a display unit is lost. This loss of the white balance can be suppressed by, for example, a method of correcting a video signal.

However, because the magnitude of the off-current depends on the temperature of the writing transistor, in the case where the temperature of the display unit varies, the loss level of the white balance also varies. It is not impossible to suppress this temperature-dependent loss of the white balance by dynamically correcting a video signal, but the configuration of a control circuit is complicated in this case.

The present disclosure has been made in order to solve the above-mentioned problem, and has an object to provide a display device and the like capable of suppressing a temperature-dependent loss of a white balance with a simplified configuration.

### Solution to Problem

In order to achieve the above object, in accordance with an aspect of the present disclosure, a display device that displays an image based on a video signal includes: a display unit including pixel circuits arranged in a matrix; and a control circuit that controls an operation of the display unit, wherein each of the pixel circuits includes a first sub-pixel circuit and a second sub-pixel circuit, the first sub-pixel circuit includes: a first light-emitting element; a first drive transistor that supplies a current to the first light-emitting element; a first capacitor that holds electric charge corresponding to the video signal; and a first writing transistor connected to the first capacitor, the second sub-pixel circuit includes: a second light-emitting element; a second drive transistor that supplies a current to the second light-emitting element; a second capacitor that holds electric charge corresponding to the video signal; and a second writing transistor connected to the second capacitor, the first capacitor has a capacitance greater than a capacitance of the second capacitor, and the control circuit controls, based on a temperature related to the display unit, a threshold compensation period of each of the first drive transistor and the second drive transistor in each of the pixel circuits.

In accordance with another aspect of the present disclosure, a control method performed by a display device that displays an image based on a video signal includes: a display unit including pixel circuits arranged in a matrix; and a control circuit that controls an operation of the display unit, wherein each of the pixel circuits includes a first sub-pixel circuit and a second sub-pixel circuit, the first sub-pixel circuit includes: a first light-emitting element; a first drive transistor that supplies a current to the first light-emitting element; a first capacitor that holds electric charge corresponding to the video signal; and a first writing transistor connected to the first capacitor, the second sub-pixel circuit includes: a second light-emitting element; a second drive transistor that supplies a current to the second light-emitting element; a second capacitor that holds electric charge corresponding to the video signal; and a second writing transistor connected to the second capacitor, and the first capacitor has a capacitance greater than a capacitance of the second capacitor, the method comprising: detecting a temperature related to the display unit; and controlling, based on the temperature detected in the detecting, a threshold compensation period of each of the first drive transistor and the second drive transistor in each of the pixel circuits.

### Advantageous Effects

The present disclosure can provide a display device and the like capable of suppressing a temperature-dependent loss of a white balance with a simplified configuration.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an overall configuration of a display device according to an embodiment.

FIG. 2 is a circuit diagram illustrating an example of a configuration of a pixel circuit according to the embodiment.

FIG. 3 is a block diagram illustrating an overall configuration of a display device according to a comparative example.

FIG. 4 is a schematic timing chart illustrating a relation between: respective control signals for a sub-pixel circuit of the display device according to the comparative example; and a source potential and a gate potential of a drive transistor.

FIG. 5 is a graph illustrating a relation between: a luminance ratio of each sub-pixel circuit according to the comparative example; and time.

FIG. 6 is a graph illustrating a relation between: an average luminance ratio per frame period of each sub-pixel circuit according to the comparative example; and the magnitude of an off-current.

FIG. 7 is a graph illustrating a relation between: an off-current ratio of each sub-pixel circuit according to the comparative example; and the temperature of a display unit.

FIG. 8 is a graph illustrating a relation between: a gate-source voltage ratio (Vgs ratio) of the drive transistor in each sub-pixel circuit according to the comparative example; and the temperature of the display unit.

FIG. 9 is a graph illustrating an example of a relation between: a threshold compensation period in the display device according to the embodiment; and the temperature of the display unit.

FIG. 10 is a schematic timing chart illustrating a relation between: respective control signals for a sub-pixel circuit of the display device according to the embodiment; and a source potential and a gate potential of a drive transistor.

FIG. 11 is a graph illustrating a relation between: the gate-source voltage ratio (Vgs ratio) of the drive transistor in each sub-pixel circuit according to each of the embodiment and the comparative example; and the temperature of the display unit.

FIG. 12 is a graph illustrating a relation between: the length of the threshold compensation period according to the embodiment; and luminance variations for each sub-pixel circuit.

FIG. 13 is a flowchart illustrating procedures of a control method performed by the display device according to the embodiment.

### DESCRIPTION OF EMBODIMENT

Hereinafter, certain exemplary embodiments will be described in detail with reference to the accompanying Drawings. The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should be noted that the respective figures are schematic diagrams and are not necessarily precise illustrations. Additionally, components that are essentially the same share like reference signs in the figures. Accordingly, overlapping explanations thereof are omitted or simplified.

### Embodiment

A display device and a drive method therefor according to an embodiment are described.

[1. Overall Configuration of Display Device]

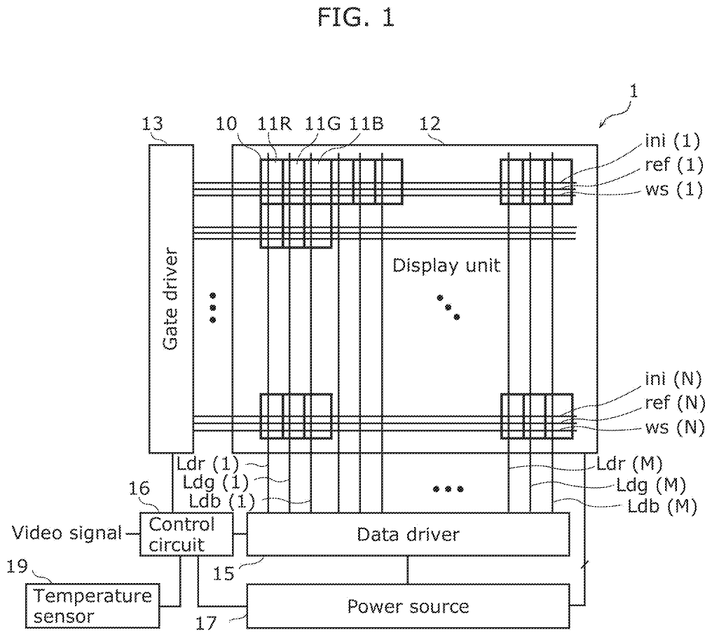

First, an overall configuration of the display device according to the present embodiment is described with reference to FIG. 1. FIG. 1 is a block diagram illustrating an overall configuration of display device 1 according to the present embodiment.

Display device 1 according to the present embodiment is a device that displays an image based on a video signal. As illustrated in FIG. 1, display device 1 includes display unit 12, gate driver 13, data driver 15, control circuit 16, power source 17, and temperature sensor 19. In the present embodiment, display device 1 is an active-matrix color display device.

Display unit 12 is an image display unit including pixel circuits 10 arranged in a matrix. Each of pixel circuits 10 includes one or more first sub-pixel circuits and one or more second sub-pixel circuits. A detailed configuration of pixel circuits 10 will be described later.

Display unit 12 includes three control signal lines ini(i), ref(i), and ws(i) (where i is an integer that is 1 or more and N or less and N is an integer that is more than 1 and indicates a row number in the matrix) connected to pixel circuits 10 arranged in each row of the matrix. Each of control signal lines ini(i), ref(i), and ws(i) transmits a control signal supplied from gate driver 13, to pixel circuits 10. Note that the number of the control signal lines and the control signal given above are an example, and the present disclosure is not limited to this example.

Display unit 12 includes three data signal lines Ldr(j), Ldg(j), and Ldb(j) (where j is an integer that is 1 or more and M or less and M is an integer that is more than 1 and indicates a column number in the matrix) connected to pixel circuits 10 arranged in each column of the matrix. Each of data signal lines Ldr(j), Ldg(j), and Ldb(j) transmits a data signal related to the light-emission luminances of R, G, and B supplied from data driver 15, to pixel circuits 10. The data signal input to each sub-pixel circuit is a signal determined based on the video signal input to control circuit 16.

Control circuit 16 is a circuit that controls an operation of display unit 12. In the present embodiment, control circuit 16 receives the video signal from the outside, and supplies a signal for displaying, on display unit 12, an image of each frame corresponding to the video signal, to gate driver 13 and data driver 15. A detailed operation of control circuit 16 will be described later.

Gate driver 13 is a circuit that outputs the control signal to display unit 12 based on the signal from control circuit 16. In the present embodiment, gate driver 13 outputs drive pulses to each of control signal lines ini(i), ref(i), and ws(i). Gate driver 13 is configured of, for example, a shift register circuit that sequentially shifts (transfers) start pulses in synchronization with clock pulses.

Data driver 15 is a circuit that outputs the data signal to display unit 12 based on the signal from control circuit 16.

Power source 17 supplies reference potentials, power source potentials, and the like to display unit 12, gate driver 13, data driver 15, and control circuit 16. Power source 17 supplies, to display unit 12, for example, reference potential VREF to be applied to reference potential line Lref, initialization potential VINI to be applied to initialization potential line Lini, a positive power source potential to be applied to positive power source line Lvcc, and a negative power source potential to be applied to negative power source line Lcat.

Temperature sensor 19 is a sensor that detects a temperature related to display unit 12. Temperature sensor 19 may detect a temperature corresponding to the temperature of display unit 12. Temperature sensor 19 may be arranged on a rear surface (a surface on a side opposite to a display surface) or the like of display unit 12, and may be provided to a drive circuit of gate driver 13, data driver 15, and the like. A configuration of temperature sensor 19 is not particularly limited. Temperature sensor 19 may be of contact type, and may be of non-contact type. Note that display device 1 need not necessarily include temperature sensor 19. For example, display device 1 may acquire information of the temperature related to display unit 12 from the outside, to thereby detect the temperature related to display unit 12.

[2. Pixel Circuit]

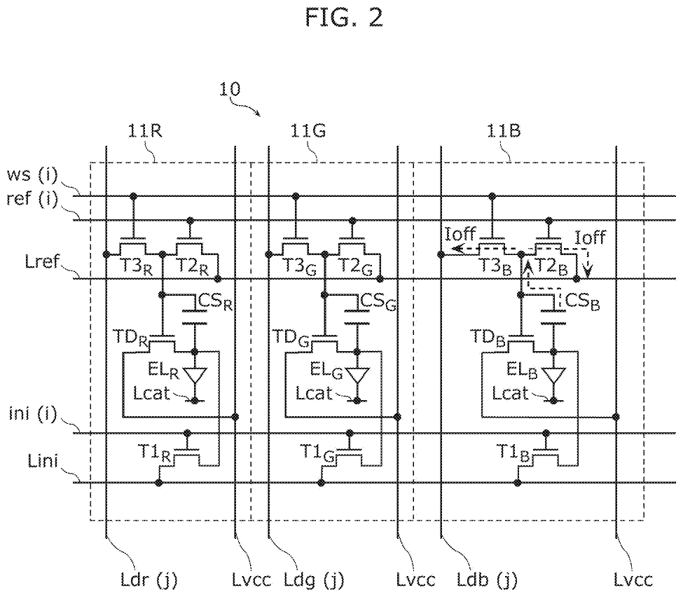

Next, a circuit configuration example of pixel circuits 10 is described with reference to FIG. 2. FIG. 2 is a circuit diagram illustrating an example of a configuration of pixel circuit 10 according to the present embodiment. In FIG. 2, pixel circuit 10 arranged in the i^{th} row and j^{th} column among pixel circuits 10 is illustrated.

As illustrated in FIG. 2, in the present embodiment, each of pixel circuits 10 includes sub-pixel circuits 11R, 11G, and 11B respectively corresponding to light-emission colors of R, G, and B. Sub-pixel circuit 11B is an example of the first sub-pixel circuit. Each of sub-pixel circuits 11R and 11G is an example of the second sub-pixel circuit. Now, sub-pixel circuits 11R, 11G, and 11B included in each pixel circuit 10 according to the present embodiment are described.

Sub-pixel circuit 11B includes initialization transistor T1_{B}, reference transistor T2_{B}, writing transistor T3_{B}, capacitor CS_{B}, drive transistor TD_{B}, and light-emitting element EL_{B}. Moreover, sub-pixel circuit 11B includes control signal lines ini(i), ref(i), and ws(i), initialization potential line Lini, reference potential line Lref, data signal line Ldb(j), positive power source line Lvcc, and negative power source line Lcat. Note that control signal lines ini(i), ref(i), and ws(i) are also referred to as a first control signal line, a second control signal line, and a third control signal line, respectively.

Drive transistor TD_{B} is an example of a first drive transistor that supplies a current to light-emitting element EL_{B}. Drive transistor TD_{B} supplies the current to light-emitting element EL_{B} in accordance with a voltage held in capacitor CS_{B}. In other words, the current according to the voltage held in capacitor CS_{B} is supplied to light-emitting element EL_{B} via drive transistor TD_{B}. As a result, light-emitting element EL_{B} emits light at a luminance specified by the data signal input to data signal line Ldb(j).

Writing transistor T3_{B} is an example of a first writing transistor connected to capacitor CS_{B}. In the present embodiment, writing transistor T3_{B} switches a conductive state between a gate electrode of drive transistor TD_{B} and data signal line Ldb(j) to which the data signal corresponding to the luminance of light-emitting element EL_{B} is input. Writing transistor T3_{B} becomes an on-state (that is, a conductive state) in response to the signal input to control signal line ws(i), and the voltage of the data signal input to data signal line Ldb(j) is held in capacitor CS_{B}.

Initialization transistor T1_{B} is an example of a first initialization transistor that switches a conductive state between light-emitting element EL_{B} and initialization potential line Lini to which initialization potential VINI is applied. Initialization transistor T1_{B} becomes the on-state in response to the control signal applied to control signal line ini(i), and sets a source electrode of drive transistor TD_{B} to initialization potential VINI applied to initialization potential line Lini.

Reference transistor T2_{B} is an example of a first reference transistor that switches a conductive state between the gate electrode of drive transistor TD_{B} and reference potential line Lref to which reference potential VREF is applied. Reference transistor T2_{B} becomes the on-state in response to the control signal input to control signal line ref(i), and sets the gate electrode of drive transistor TD_{B} to reference potential VREF applied to reference potential line Lref.

Capacitor CS_{B} is an example of a first capacitor that holds electric charge corresponding to the video signal. In other words, capacitor CS_{B} holds the electric charge and the voltage corresponding to the data signal input to sub-pixel circuit 11B.

Light-emitting element EL_{B} is an example of a first light-emitting element that emits light in sub-pixel circuit 11B. In the present embodiment, light-emitting element EL_{B} is a blue organic EL element that emits blue light.

Sub-pixel circuit 11R includes initialization transistor T1_{R}, reference transistor T2_{R}, writing transistor T3_{R}, capacitor CS_{R}, drive transistor TD_{R}, and light-emitting element EL_{R}. Sub-pixel circuit 11G includes initialization transistor T1_{G}, reference transistor T2_{G}, writing transistor T3_{G}, capacitor CS_{G}, drive transistor TD_{G}, and light-emitting element EL_{G}. Similarly to sub-pixel circuit 11B, each of sub-pixel circuits 11R and 11G includes control signal lines ini(i), ref(i), and ws(i), initialization potential line Lini, reference potential line Lref, positive power source line Lvcc, and negative power source line Lcat. Moreover, each of sub-pixel circuits 11R and 11G includes data signal lines Ldr(j) and Ldg(j).

Drive transistors TD_{R} and TD_{G} are an example of second drive transistors that supply currents to light-emitting elements EL_{R} and EL_{G}, respectively. Drive transistors TD_{R} and TD_{G} supply the currents to light-emitting elements EL_{R} and EL_{G} in accordance with the voltages held in capacitors CS_{R} and CS_{G}, respectively. In other words, the currents according to the voltages held in capacitors CS_{R} and CS_{G} are supplied to light-emitting elements EL_{R} and EL_{G} via drive transistors TD_{R} and TD_{G}, respectively. As a result, light-emitting elements EL_{R} and EL_{G} emit light at luminances specified by the data signals input to data signal lines Ldr(j) and Ldg(j), respectively. Writing transistors T3_{R} and T3_{G} are an example of second writing transistors connected to capacitors CS_{R} and CS_{G}, respectively. In the present embodiment, writing transistors T3_{R} and T3_{G} switch conductive states between: gate electrodes of drive transistors TD_{R} and TD_{G}; and data signal lines Ldr(j) and Ldg(j) to which the data signals corresponding to the luminances of light-emitting elements EL_{R} and EL_{G} are input, respectively. Writing transistors T3_{R} and T3_{G} become the on-state in response to the signal input to control signal line ws(i), and the voltages of the data signals input to data signal lines Ldr(j) and Ldg(j) are held in capacitors CS_{R} and CS_{G}, respectively.

Initialization transistors T1_{R} and T1_{G} are an example of second initialization transistors that switch conductive states between light-emitting elements EL_{R} and EL_{G} and initialization potential line Lini to which initialization potential VINI is applied, respectively. Initialization transistors T1_{R} and T1_{G} become the on-state in response to the control signal applied to control signal line ini(i), and set source electrodes of drive transistors TD_{R} and TD_{G} to initialization potential VINI applied to initialization potential line Lini, respectively.

Reference transistors T2_{R} and T2_{G} are an example of second reference transistors that switch conductive states between: the gate electrodes of drive transistors TD_{R} and TD_{G}; and reference potential line Lref to which reference potential VREF is applied, respectively. Reference transistors T2_{R} and T2_{G} become the on-state in response to the control signal input to control signal line ref(i), and set the gate electrodes of drive transistors TD_{R} and TD_{G} to reference potential VREF applied to reference potential line Lref, respectively.

Capacitors CS_{R} and CS_{G} are an example of second capacitors that hold electric charge corresponding to the video signals, respectively. In other words, capacitors CS_{R} and CS_{G} hold the electric charge and the voltages corresponding to the data signals input to sub-pixel circuits 11R and 11G, respectively.

Light-emitting elements EL_{R} and EL_{G} are an example of second light-emitting elements that emit light in sub-pixel circuits 11R and 11G, respectively. In the present embodiment, light-emitting elements EL_{R} and EL_{G} are a red organic EL element that emits red light and a green organic EL element that emits green light, respectively.

Among the respective light-emitting elements of the sub-pixel circuits, the light emission lifetime of an organic EL material used for light-emitting element EL_{B} as the blue organic EL element is shorter than the light emission lifetimes of organic EL materials respectively used for light-emitting element EL_{R} as the red organic EL element and light-emitting element EL_{G} as the green organic EL element. Therefore, in the present embodiment, the pixel area of light-emitting element EL_{B} is set to be larger than the pixel areas of light-emitting elements EL_{R} and EL_{G}, whereby the current density in light-emitting element EL_{B} is reduced. Consequently, in sub-pixel circuit 11B including light-emitting element EL_{B}, the capacitance of capacitor CS_{B} as the first capacitor is designed to be greater than the respective capacitances of capacitors CS_{R} and CS_{G} as the second capacitors, considering a balance with the characteristic of light-emitting element EL_{B}.

The configurations of the above-mentioned transistors are not particularly limited, and the above-mentioned transistors are, for example, a silicon-based semiconductor thin film transistor. Moreover, N-channel MOSFETs can be used as the above-mentioned transistors. Note that the sub-pixel circuits can also be configured using transistors other than N-channel MOSFETs. For example, the sub-pixel circuits can also be configured using P-channel MOSFETs.

Because each pixel circuit 10 has such a configuration as described above, in sub-pixel circuits 11R, 11G, and 11B, data signals Vdat_{R}, Vdat_{G}, and Vdat_{B} are respectively held at the same timing in response to the same control signal, and light-emitting elements EL_{R}, EL_{G}, and EL_{B} respectively emit light at luminances according to the held data signals.

[3. Control Mode and Effect]

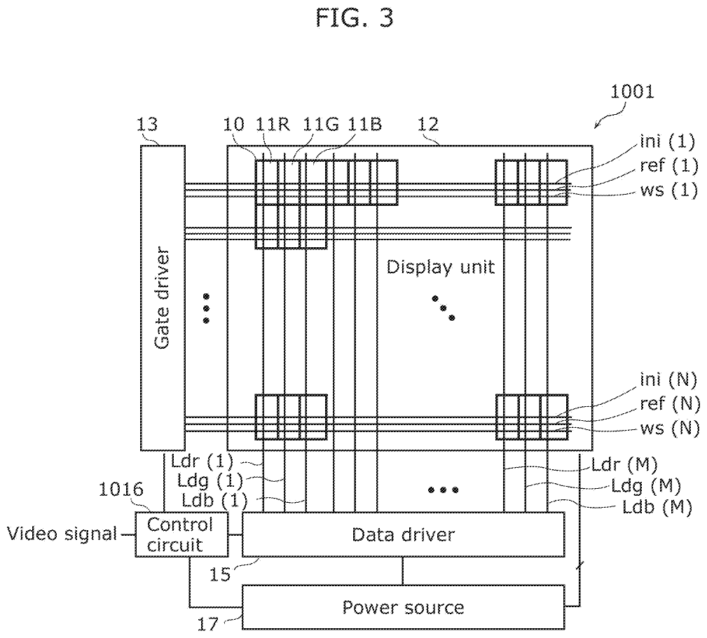

Next, a control mode and an effect of display device 1 are described with reference to FIG. 3 to FIG. 12 in comparison with a comparative example.

FIG. 3 is a block diagram illustrating an overall configuration of display device 1001 according to the comparative example. As illustrated in FIG. 3, display device 1001 according to the comparative example includes display unit 12, gate driver 13, data driver 15, control circuit 1016, and power source 17. That is, display device 1001 according to the comparative example is different from display device 1 according to the present embodiment in that temperature sensor 19 is not provided and in the configuration of control circuit 1016, and display device 1001 is identical with display device 1 in the other features.

Control circuit 1016 is a circuit that controls an operation of display unit 12. Control circuit 1016 receives a video signal from the outside, and supplies a signal for displaying, on display unit 12, an image of each frame corresponding to the video signal, to gate driver 13 and data driver 15.

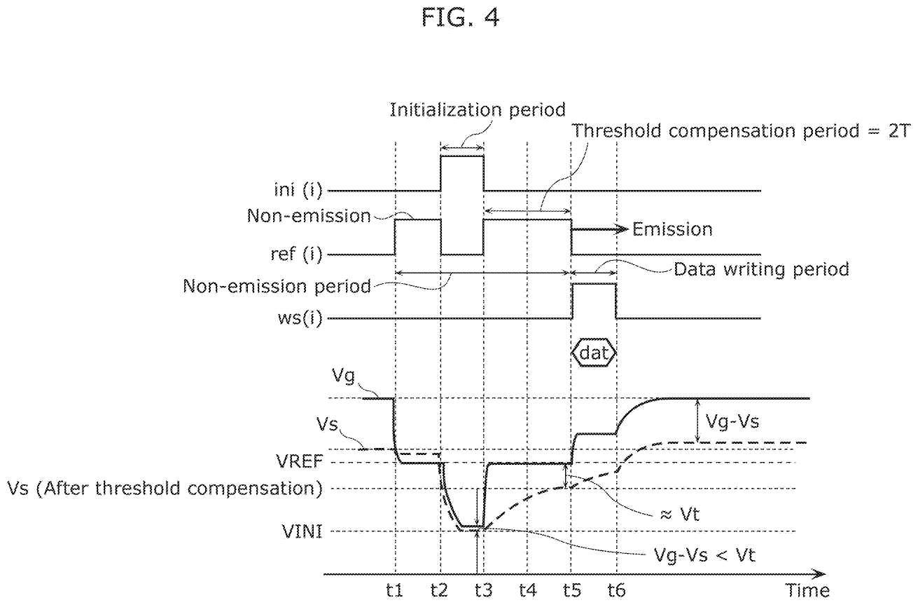

Now, a control mode of control circuit 1016 according to the comparative example is described with reference to FIG. 2 to FIG. 4. FIG. 4 is a schematic timing chart illustrating a relation between: respective control signals for sub-pixel circuit 11B of display device 1001 according to the comparative example; and source potential Vs and gate potential Vg of drive transistor TD_{B}. Note that sub-pixel circuit 11B among sub-pixel circuits 11R, 11G, and 11G is described here, but timing charts of the sub-pixel circuits of the other colors are the same as the timing chart of sub-pixel circuit 11B.

As illustrated in FIG. 4, until time point t1, all the control signals are in an L level, and light-emitting element EL_{B} is in a light emission state corresponding to a data signal in a previous vertical period.

Subsequently, at time point t1, a drive pulse is input to control signal line ref(i). As a result, from time point t1 to time point t2, the control signal input to control signal line ref(i) is in an H level. Consequently, a portion between a source electrode and a drain electrode of reference transistor T2_{B} becomes the on-state, and hence the gate electrode of drive transistor TD_{B} and reference potential line Lref are connected to each other. As a result, potential Vg of the gate electrode of drive transistor TD_{B} and the potential of one of electrodes of capacitor CS_{B} become equal to reference potential VREF. Here, reference potential VREF is, for example, approximately +1 V. In this way, light-emitting element EL_{B} is caused not to emit light. That is, the drive pulse that is input to control signal line ref(i) at time point t1 is a non-emission pulse. Because the non-emission pulse is input to control signal line ref(i), gate-source voltage Vgs (that is, difference Vg-Vs between gate potential Vg and source potential Vs) of drive transistor TD_{B} can be made smaller than threshold Vt of drive transistor TD_{B}. Therefore, a voltage drop of initialization potential line Lini due to an on-current flowing in drive transistor TD_{B} can be suppressed.

Subsequently, at time point t2, the control signal input to control signal line ref(i) becomes the L level, and a drive pulse is input to control signal line ini(i). As a result, from time point t2 to time point t3, the control signal input to control signal line ini(i) becomes the H level. Consequently, a portion between a source electrode and a drain electrode of initialization transistor T1_{B} becomes the on-state, and hence an anode electrode of light-emitting element EL_{B} and initialization potential line Lini are connected to each other. As a result, the potential of the anode electrode of light-emitting element EL_{B} and potential Vs of the source electrode of drive transistor TD_{B} become equal to initialization potential VINI. Here, initialization potential VINI is, for example, approximately −2 V, and, from time point t2 to time point t3, the potential of the anode electrode of light-emitting element EL_{B} and potential Vs of the source electrode of drive transistor TD_{B} decrease from a potential of approximately +1 V or more to a potential of approximately −2 V. Consequently, potential Vg of the gate electrode of drive transistor TD_{B} also decreases.

As described above, in the case where the control signal input to control signal line ini(i) is in the L level and the H level, initialization transistor T1_{R} becomes the off-state and the on-state, respectively. Here, initialization potential VINI is applied to the source electrode of initialization transistor T1_{B}. In the case where the control signal is in the L level, in order to bring initialization transistor T1_{R} into the off-state, the L level of the control signal, that is, the L level of the drive pulse is set to be a potential lower than initialization potential VINI. In the present comparative example, the L level and the H level of the drive pulse are set to, for example, approximately −4 V and approximately 10 V, respectively.

Note that, in the present embodiment, during an initialization period from time point t2 to time point t3, a relatively large on-current flows in drive transistor TD_{B}, and a voltage drop of initialization potential line Lini can occur. Therefore, the potential to be applied to initialization potential line Lini may be increased by an amount of the voltage drop.

Subsequently, at time point t3, the control signal input to control signal line ini(i) becomes the L level, and a drive pulse is input to control signal line ref(i). As a result, from time point t3 to time point t5, the control signal input to control signal line ref(i) becomes the H level. Consequently, the portion between the source electrode and the drain electrode of reference transistor T2_{B} becomes the on-state. As a result, the potential of the gate electrode of drive transistor TD_{B} and the potential of one of the electrodes of capacitor CS_{B} become equal to reference potential VREF. Here, reference potential VREF is, for example, approximately +1 V. In this way, threshold compensation of drive transistor TD_{B} can be achieved. That is, difference Vg-Vs between gate potential Vg and source potential Vs of drive transistor TD_{B} becomes equal to threshold Vt. The period from time point t3 to time point t5 is a threshold compensation period. In the present comparative example, the threshold compensation period is 2T. Here, time T is time whose length is determined based on the configuration of each sub-pixel circuit and the like.

Subsequently, at time point t5, the control signal input to control signal line ref(i) becomes the L level, and a drive pulse is input to control signal line ws(i). As a result, from time point t5 to time point t6, the control signal input to control signal line ws(i) becomes the H level. Consequently, a portion between a source electrode and a drain electrode of writing transistor T3_{B} becomes the on-state. As a result, the potential of the gate electrode of drive transistor TD_{B} and the potential of one of the electrodes of capacitor CS_{B} become equal to the voltage of the data signal applied to data signal line Ldb(j). That is, the period from time point t5 to time point t6 is a data writing period. In this way, the voltage corresponding to the data signal is held in capacitor CS_{B}, whereby drive transistor TD_{B} supplies the current corresponding to the data signal to light-emitting element EL_{B}. Accordingly, light-emitting element EL_{B} emits light at a luminance corresponding to the data signal. Other sub-pixel circuits 11R and 11G operate in a manner similar to that of sub-pixel circuit 11B.

According to the control mode described above, an image corresponding to a video signal can be displayed in display device 1001.

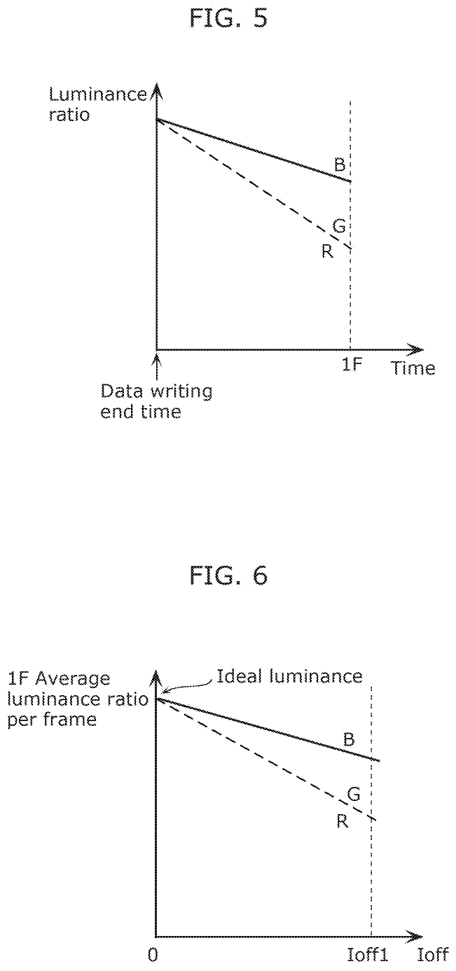

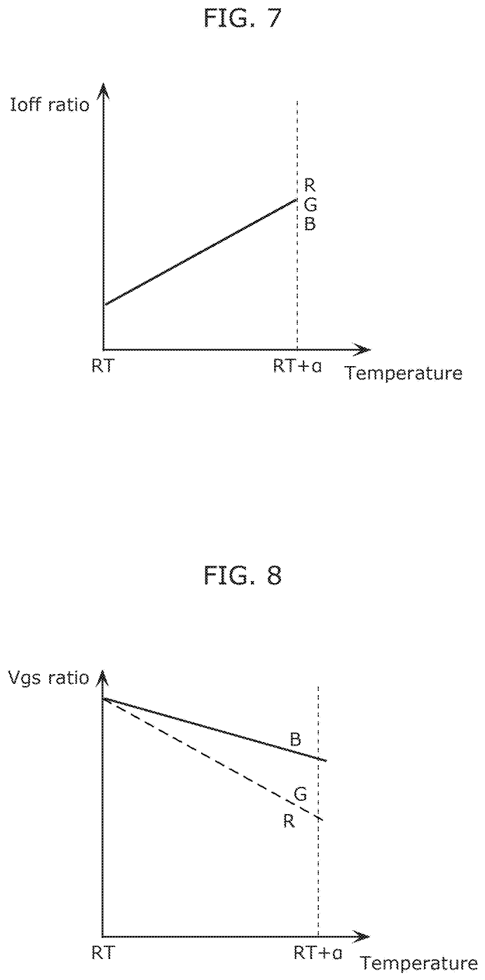

Here, a problem of display device 1001 according to the comparative example is described with reference to FIG. 5 to FIG. 8. FIG. 5 is a graph illustrating a relation between: a luminance ratio of each sub-pixel circuit according to the comparative example; and time. Time after data writing end time (time point t6 in FIG. 4) is shown on the horizontal axis of FIG. 5. FIG. 6 is a graph illustrating a relation between: an average luminance ratio per frame period of each sub-pixel circuit according to the comparative example; and the magnitude of the off-current. Here, the luminance ratio means the ratio of: an actual luminance of each sub-pixel circuit; to an ideal luminance that is a perfect luminance assumed in the case where a predetermined data signal is supplied to each sub-pixel circuit. FIG. 7 is a graph illustrating a relation between: an off-current ratio of each sub-pixel circuit according to the comparative example; and the temperature of display unit 12. Here, the off-current ratio (Ioff ratio) means the ratio of the amount of off-current to the amount of off-current at room temperature (RT). FIG. 8 is a graph illustrating a relation between: a gate-source voltage ratio (Vgs ratio) of the drive transistor in each sub-pixel circuit according to the comparative example; and the temperature of display unit 12. Here, the gate-source voltage ratio (Vgs ratio) of the drive transistor means the ratio of the gate-source voltage to gate-source voltage Vgs at room temperature. In FIG. 5 to FIG. 8, graphs concerning sub-pixel circuit 11B are indicated by solid lines (see reference sign B in each figure), and graphs concerning sub-pixel circuits 11R and 11G are indicated by broken lines (see reference signs R and G in each figure). Note that the solid-line graph and the broken-line graph overlap with each other in FIG. 7.

In each sub-pixel circuit of display device 1001, even in the case where the writing transistor and the reference transistor are in the off-state, off-current Ioff flows as illustrated in sub-pixel circuit 11B in FIG. 2. Note that, although off-current Ioff is illustrated only in sub-pixel circuit 11B in FIG. 2, off-current Ioff similarly flows also in other sub-pixel circuits 11R and 11G. As a result, after data writing (that is, after electric charge corresponding to the luminance value is accumulated in capacitor CS_{B}), the electric charge is released from capacitor CS_{B} via writing transistor T3_{B} and reference transistor T2_{B}. Here, the luminance value of sub-pixel circuit 11B (that is, the luminance value of light-emitting element EL_{B}) corresponds to gate-source voltage Vgs of drive transistor TD_{B}, and gate-source voltage Vgs depends on the electric charge accumulated in capacitor CS_{B}. As described above, the capacitance of the capacitor of sub-pixel circuit 11B is greater than the capacitances of the sub-pixel circuits of the other colors. On the other hand, the amounts of electric charge respectively released from capacitors CS_{R}, CS_{G}, and CS_{B} of the sub-pixel circuits by off-current Ioff are equivalent to one another. Accordingly, for the ratio of: the amount of electric charge released from each capacitor by off-current Ioff; to the capacitance of the capacitor, sub-pixel circuit 11B is lower than other sub-pixel circuits 11R and 11G.

Here, the capacitances of capacitors CS_{R}, CS_{G}, and CS_{B} are respectively represented by C_{R}, C_{G}, and C_{B}, and the electric charge released from each capacitor by off-current Ioff is represented by Qc. Moreover, the amounts of decrease in the voltages applied to capacitors CS_{R}, CS_{G}, and CS_{B} (that is, the gate-source voltages of drive transistors TD_{R}, TD_{A} and TD_{B}) by the off-current are represented by ΔVgs_{R}, ΔVgs_{G}, and ΔVgs_{B}, respectively. In this case, the following expressions are established.

ΔVgs_{R}=Qc/C_{R} (1)

ΔVgs_{G}=Qc/C_{G} (2)

ΔVgs_{B}=Qc/C_{B} (3)

C_{B}>C_{R}=C_{G} (4)

Accordingly, the following expression is established.

ΔVgs_{B}<ΔVgs_{R}=ΔVgs_{G} (5)

The gate-source voltage of each drive transistor corresponds to the luminance value of the light-emitting element to which the current is supplied from the drive transistor. Accordingly, for the amount of decrease in the luminance value resulting from off-current Ioff, light-emitting element EL_{B} is smaller than light-emitting elements EL_{R} and EL_{G}. Accordingly, as illustrated in FIG. 5, although the luminance ratio decreases over time for every sub-pixel circuit after data writing, the amount of decrease in the luminance ratio of sub-pixel circuit 11B is smaller than the amount of decrease in the luminance ratio of each of sub-pixel circuits 11R and 11G. Therefore, as illustrated in FIG. 6, also for the amount of decrease in the average luminance ratio per frame resulting from off-current Ioff, sub-pixel circuit 11B is smaller than sub-pixel circuits 11R and 11G. In this way, the amount of decrease in the luminance ratio resulting from off-current Ioff is different between sub-pixel circuit 11B and sub-pixel circuits 11R and 11G, and hence the white balance of display unit 12 is lost. This loss of the white balance can be suppressed by, for example, a method of correcting a video signal.

However, as illustrated in FIG. 7, the magnitude of off-current Ioff depends on the temperatures of each writing transistor and each reference transistor (that is, the temperature of display unit 12). Therefore, as illustrated in FIG. 8, the relation between: the gate-source voltage ratio of drive transistor TD_{B} in sub-pixel circuit 11B; and the gate-source voltage ratios of drive transistors TD_{R} and TD_{A} in sub-pixel circuits 11R and 11G changes in accordance with the temperature. Therefore, in the case where the temperature of display unit 12 varies, the loss level of the white balance also varies. It is not impossible to suppress this temperature-dependent loss of the white balance by, for example, dynamically correcting a video signal, but the configuration of control circuit 1016 is complicated in this case.

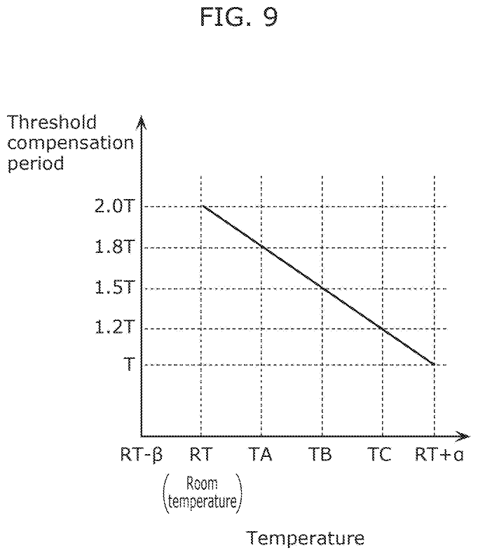

In order to reduce this loss of the white balance, in display device 1 according to the present embodiment, control circuit 16 controls the threshold compensation period of each of the drive transistors in each of pixel circuits 10, based on the temperature related to display unit 12. More specifically, control circuit 16 shortens the threshold compensation period as the temperature related to display unit 12 increases. Here, the relation between the threshold compensation period in display device 1 according to the present embodiment and the temperature of display unit 12 is described with reference to FIG. 9. FIG. 9 is a graph illustrating an example of the relation between: the threshold compensation period in display device 1 according to the present embodiment; and the temperature of display unit 12.

As illustrated in FIG. 9, in the present embodiment, the threshold compensation period is 2.0T at room temperature similarly to the comparative example, but the threshold compensation period shortens as the temperature of display unit 12 increases. Note that control circuit 16 according to the present embodiment is different from control circuit 1016 according to the comparative example, in the control mode in which the threshold compensation period is controlled based on the temperature related to display unit 12, and control circuit 16 is identical with control circuit 1016 in other control modes.

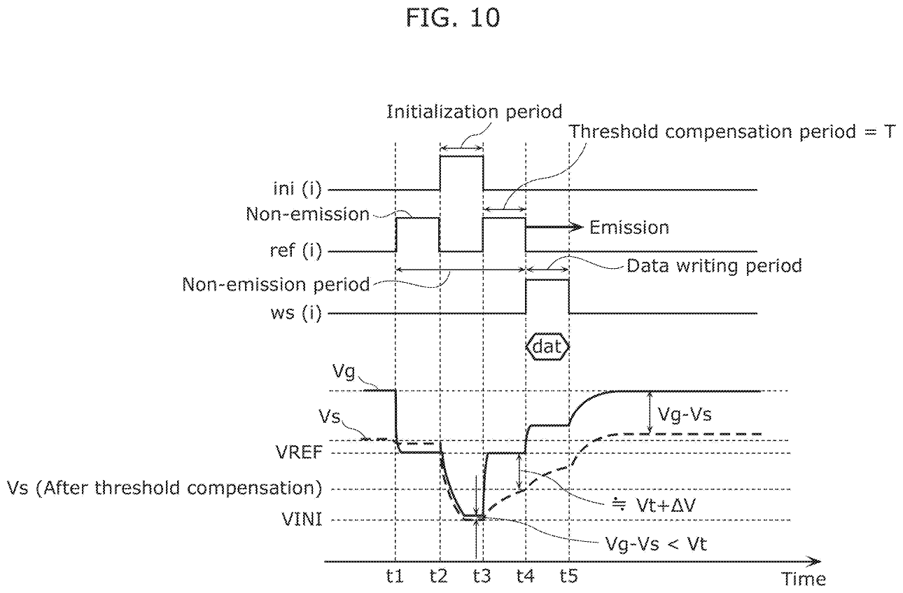

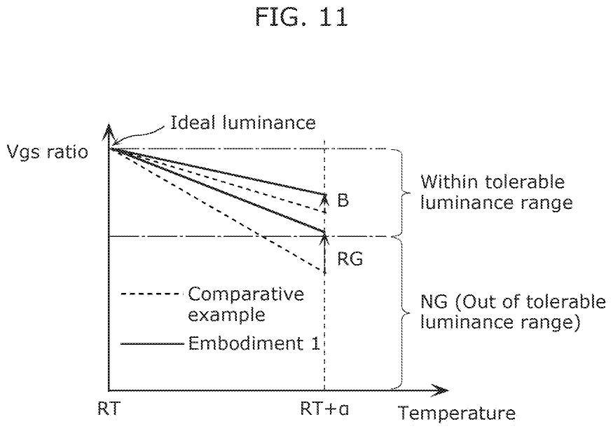

Here, an effect produced by controlling the threshold compensation period in display device 1 according to the present embodiment is described with reference to FIG. 10 and FIG. 11. FIG. 10 is a schematic timing chart illustrating a relation between: respective control signals for sub-pixel circuit 11B of display device 1 according to the present embodiment; and source potential Vs and gate potential Vg of drive transistor TD_{B}. FIG. 10 is a timing chart in the case of temperature RT+α illustrated in FIG. 9 at which the temperature of display unit 12 is higher than room temperature RT. FIG. 11 is a graph illustrating a relation between: the gate-source voltage ratio (Vgs ratio) of the drive transistor in each sub-pixel circuit according to each of the present embodiment and the comparative example; and the temperature of display unit 12. In FIG. 11, graphs concerning the present embodiment and the comparative example are illustrated by a solid line and a dotted line, respectively.

As described above, control circuit 16 according to the present embodiment controls the threshold compensation period of each of the drive transistors in each of pixel circuits 10, based on the temperature related to display unit 12. In the case where the temperature of display unit 12 is temperature RT+α higher than room temperature RT, control circuit 16 controls gate driver 13 such that the threshold compensation period is T. As a result, as illustrated in FIG. 10, the threshold compensation period ends in the state where the gate-source voltage (Vgs=Vg−Vs) of the drive transistor is greater than threshold Vt. The effect produced by such control is described below more in detail.

For example, discussed is the case where capacitance C_{B} of capacitor CS_{B} is twice each of capacitance C_{R} of capacitor CS_{R} and capacitance C_{G} of capacitor CS_{G} and where the amount of current discharged by each of capacitors CS_{R}, CS_{G}, and CS_{B} in the threshold compensation period is represented by Ic. Note that off-current Ioff is not considered here.

First, the discharge capacity of each of capacitors CS_{R}, CS_{G}, and CS_{B} in the case where the temperature of display unit 12 is room temperature is represented by Ic×2T. Accordingly, the amount of change in the threshold compensation period (2T), of the gate-source voltage of each of drive transistors TD_{R} and TD_{G} is represented by Ic×2T/C_{R} (=Ic×2T/C_{G}). Moreover, the amount of change in the threshold compensation period (2T), of the gate-source voltage of drive transistor TD_{B} is represented by Ic×2T/C_{B}. Here, because capacitance C_{B} is twice each of capacitances C_{R} and C_{G}, Ic×2T/C_{B} is represented as Ic×T/C_{R}. That is, if the amount of change in the threshold compensation period, of the gate-source voltage of drive transistor TD_{B} is represented as ΔVx, the amount of change in the threshold compensation period (2T), of the gate-source voltage of each of drive transistors TD_{R} and TD_{G} can be represented as 2ΔVx.

Accordingly, gate-source voltage Vgs_rg of each of drive transistors TD_{R} and TD_{G} and gate-source voltage Vgs_b of drive transistor TD_{B} after the threshold compensation period in the case where the temperature of display unit 12 is room temperature are represented as follows.

Vgs_rg=Vt+VREF−VINI−2ΔVx (6)

Vgs_b=Vt+VREF−VINI−ΔVx (7)

On the other hand, in the case where the temperature of display unit 12 is temperature RT+α higher than room temperature, the threshold compensation period is T, and hence the discharge capacity of each of capacitors CS_{R}, CS_{G}, and CS_{B} is represented by Ic×T. Accordingly, the amount of change in the threshold compensation period (T), of the gate-source voltage of each of drive transistors TD_{R} and TD_{G} is represented by Ic×T/C_{R} (=Ic×T/C_{G}). Moreover, the amount of change in the threshold compensation period (T), of the gate-source voltage of drive transistor TD_{B} is represented by Ic×T/C_{B}. Here, because capacitance C_{B} is twice each of capacitances C_{R} and C_{G}, Ic×2T/C_{B} is represented as Ic×T/(2C_{R}). That is, if the amount of change ΔVx described above is used, the amount of change in the threshold compensation period, of the gate-source voltage of drive transistor TD_{B} can be represented as ΔVx/2. Moreover, the amount of change in the threshold compensation period (T), of the gate-source voltage of each of drive transistors TD_{R} and TD_{G} can be represented as ΔVx.

Accordingly, gate-source voltage Vgs_rg of each of drive transistors TD_{R} and TD_{G} and gate-source voltage Vgs_b of drive transistor TD_{B} after the threshold compensation period in the case where the temperature of display unit 12 is room temperature are represented as follows.

Vgs_rg=Vt+VREF−VINI−ΔVx (8)

Vgs_b=Vt+VREF−VINI−ΔVx/2 (9)

As described above, in the case where off-current Ioff is not considered, gate-source voltage Vgs_b of drive transistor TD_{B} is higher by ΔVx/2 at temperature RT+α higher than room temperature than at room temperature. On the other hand, gate-source voltage Vgs_rg of each of drive transistors TD_{R} and TD_{G} is higher by ΔVx at temperature RT+α higher than room temperature than at room temperature. That is, for the amount of increase in the gate-source voltage, that is, the amount of increase in the luminance of the sub-pixel circuit by changing the threshold compensation period, drive transistor TD_{B} is smaller than drive transistors TD_{R} and TD_{G}.

As described above, the amount of decrease in the luminance by off-current Ioff becomes larger as the temperature increases. Accordingly, in display device 1 according to the present embodiment, control circuit 16 controls the threshold compensation period of each of the drive transistors, based on the temperature related to display unit 12, whereby at least part of the decrease in the luminance by off-current Ioff can be compensated. More specifically, control circuit 16 shortens the threshold compensation period as the temperature related to display unit 12 increases. As a result, as illustrated in FIG. 11, the decrease in the gate-source voltage Vgs ratio in each sub-pixel circuit due to the temperature increase can be suppressed, and hence luminance variations resulting from off-current Ioff can be caused to fall within a tolerable luminance range. That is, the temperature-dependent loss of the white balance in display device 1 can be suppressed. Moreover, the above-mentioned control by control circuit 16 can be realized by varying timing of drive pulses output from gate driver 13, based on the temperature detected by temperature sensor 19, and hence control circuit 16 can be realized with a simplified configuration.

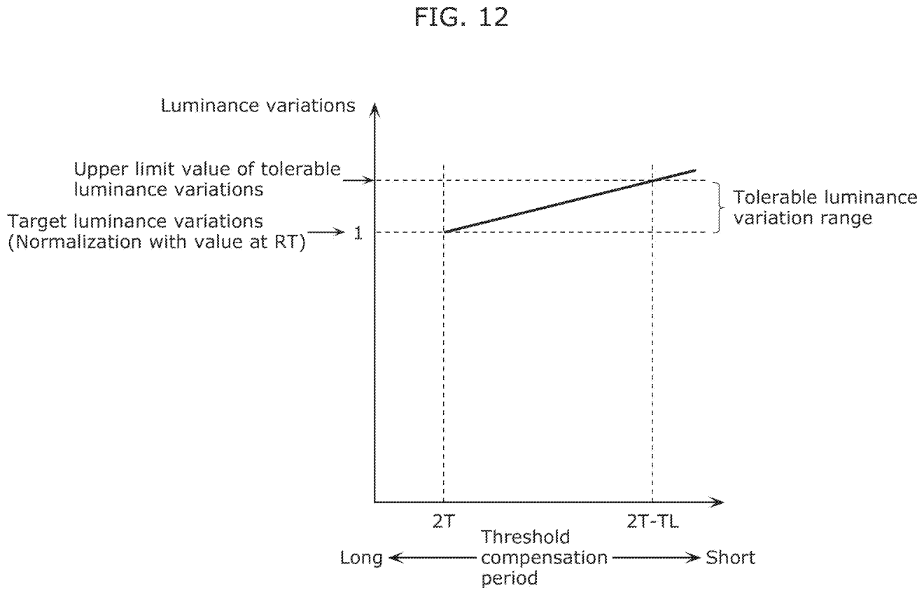

Note that, in conventional display devices, in order to sufficiently complete threshold compensation for every sub-pixel circuit, a sufficiently long threshold compensation period is secured. On the other hand, in display device 1 according to the present embodiment, in the case where the temperature of display unit 12 is high, the threshold compensation period is shortened, and hence the threshold compensation level may vary for each sub-pixel circuit. Luminance variations for each sub-pixel circuit resulting from such variations in the threshold compensation level are described with reference to FIG. 12. FIG. 12 is a graph illustrating a relation between: the length of the threshold compensation period according to the present embodiment; and the luminance variations for each sub-pixel circuit. In FIG. 12, the length of the threshold compensation period is shown on the horizontal axis, and the magnitude of the luminance variations is shown on the vertical axis. Note that the length of the threshold compensation period on the horizontal axis becomes shorter from left to right.

As illustrated in FIG. 12, as the threshold compensation period becomes shorter, the threshold compensation level varies, and, as a result, the luminance variations become larger. In view of this, in the present embodiment, a minimum value (2T-TL in FIG. 12) of the threshold compensation period may be obtained such that these luminance variations fall within the tolerable range, and such control that the threshold compensation period is equal to or more than the minimum value may be performed. As a result, the luminance variations can be caused to fall within the tolerable range.

[4. Control Method]

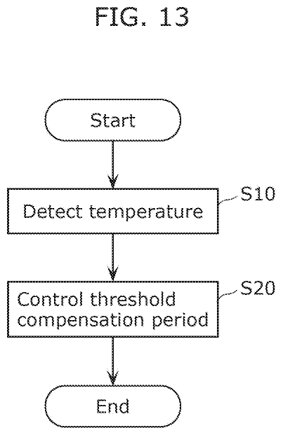

Next, a control method performed by display device 1 according to the present embodiment is described with reference to FIG. 13. FIG. 13 is a flowchart illustrating procedures of the control method performed by display device 1 according to the present embodiment.

As illustrated in FIG. 13, first, control circuit 16 detects the temperature related to display unit 12 (S10). In the present embodiment, control circuit 16 detects the temperature related to display unit 12 based on the signal from temperature sensor 19.

Subsequently, control circuit 16 controls the threshold compensation period of each of the first drive transistor and the second drive transistor in each of pixel circuits 10 (S20). Specifically, control circuit 16 shortens the threshold compensation period of each of drive transistors TD_{R}, TD_{A}, and TD_{B} as the temperature related to display unit 12 increases.

According to the above-mentioned control method, as described above, the temperature-dependent loss of the white balance can be suppressed with a simplified configuration.

### OTHER EMBODIMENTS

Although the display device and the like according to one or more aspects of the present disclosure have been described based on embodiments, they are not limited to these embodiments. Those skilled in the art will readily appreciate that embodiments arrived at by making various modifications to the above embodiments, embodiments arrived at by selectively combining elements disclosed in the above embodiments without materially departing from the scope of the present disclosure, or various devices including the processing circuits disclosed in the above embodiments may be included within one or more aspects of the present disclosure.

For example, in the above-mentioned embodiment, the organic EL elements are used as the light-emitting elements, but the light-emitting elements are not limited to the organic EL elements. For example, quantum-dot light emitting diodes (QLEDs) may be used as the light-emitting elements.

Moreover, the configuration of the pixel circuits in the display device according to the present disclosure is not limited to the configuration of the pixel circuits used in the above-mentioned embodiment. For example, each pixel circuit may include only one or two sub-pixel circuits, and may include four or more sub-pixel circuits. Moreover, the configuration of the sub-pixel circuits is not limited to the configuration of the sub-pixel circuits used in the above-mentioned embodiment. Other publicly known sub-pixel circuits may be used as the sub-pixel circuits.

Moreover, the arrangement configuration of the sub-pixel circuits in each pixel circuit 10 is not limited to a stripe-type arrangement configuration as in the above-mentioned embodiment. For example, the arrangement configuration of the sub-pixel circuits may be an S-stripe-type or pentile-type arrangement configuration.

Moreover, in the above-mentioned embodiment, gate driver 13 inputs signals from only one side of display unit 12, but may input signals from both sides of display unit 12.

Moreover, a chip-on-glass (COG) mounting mode may be adopted as the mounting mode of data driver 15, and a chip-on-flexible (COF) mounting mode may be adopted thereas.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure can be widely applied as a display device that can suppress a loss of a white balance, to various video display devices such as a personal digital assistant, a personal computer, and a television receiver.

1. A display device that displays an image based on a video signal, the display device comprising:
a display unit including pixel circuits arranged in a matrix; and
a control circuit that controls an operation of the display unit, wherein
each of the pixel circuits includes a first sub-pixel circuit and a second sub-pixel circuit,
the first sub-pixel circuit includes:
a first light-emitting element;
a first drive transistor that supplies a current to the first light-emitting element;
a first capacitor that holds electric charge corresponding to the video signal; and
a first writing transistor connected to the first capacitor, the second sub-pixel circuit includes:
a second light-emitting element;
a second drive transistor that supplies a current to the second light-emitting element;
a second capacitor that holds electric charge corresponding to the video signal; and
a second writing transistor connected to the second capacitor,
the first capacitor has a capacitance greater than a capacitance of the second capacitor, and
the control circuit controls, based on a temperature related to the display unit, a threshold compensation period of each of the first drive transistor and the second drive transistor in each of the pixel circuits.

2. The display device according to claim 1, wherein
the control circuit shortens the threshold compensation period as the temperature increases.

3. The display device according to claim 1, wherein
the first light-emitting element is an organic electroluminescent (EL) element that emits blue light, and
the second light-emitting element is an organic EL element that emits green or red light.

4. The display device according to claim 1, wherein
each of the first writing transistor and the second writing transistor is a silicon-based semiconductor thin film transistor.

5. A control method performed by a display device that displays an image based on a video signal, the display device including:
a display unit including pixel circuits arranged in a matrix; and
a control circuit that controls an operation of the display unit, wherein
each of the pixel circuits includes a first sub-pixel circuit and a second sub-pixel circuit,
the first sub-pixel circuit includes:
a first light-emitting element;
a first drive transistor that supplies a current to the first light-emitting element;
a first capacitor that holds electric charge corresponding to the video signal; and
a first writing transistor connected to the first capacitor, the second sub-pixel circuit includes:
a second light-emitting element;
a second drive transistor that supplies a current to the second light-emitting element;
a second capacitor that holds electric charge corresponding to the video signal; and
a second writing transistor connected to the second capacitor, and
the first capacitor has a capacitance greater than a capacitance of the second capacitor,
the method comprising:
detecting a temperature related to the display unit; and
controlling, based on the temperature detected in the detecting, a threshold compensation period of each of the first drive transistor and the second drive transistor in each of the pixel circuits.

6. The control method according to claim 5, wherein
the controlling includes shortening the threshold compensation period as the temperature increases.
